(19) United States
(12) Patent Application Publication
(10) Pub. No.: US 2002/0088134 A1
(43) Pub. Date: Jul. 11, 2002

(54) Measurement device

(76) Inventor: Ed Watts, North Logan, UT (US)

Correspondence Address: Thompson E. Fehr, Suite 703, The Aerospace Center, 1104 Country Hills Drive, Ogden, UT, 84403, US

(21) Appl. No.: 09/756,664

(22) Filed: Jan. 10, 2001

(51) Int. Cl. G01B 3/10

(52) U.S. Cl. 33/760; 33/1 CC; 33/759

(57) ABSTRACT

A measurement device for locating positions and creating layouts on a surface. An upper section is rotatably attached to a base. The upper section has a first releasable fastener to hold an end of a measuring tape. The releasable fastener lies at a known distance along a radius from the point of rotation for the upper section. Optional second and third fasteners on the upper section permit the end of a measuring tape having a reel to be placed in second and third fasteners; the other end of the measuring tape runs through the first releasable fastener. Attached to the base is a device which indicates on a surface upon which a measurement is to be made the projection of the point of rotation of the upper section. The base can be fastened either to the surface or to a tripod, in case the surface is not level. For accommodating less pronounced variations in the surface, an extension tube is inserted on the base rotatably to hold the upper section. With three bases, four upper sections, and two measuring tapes, a desired point can be located on a given surface.

### BACKGROUND OF THE INVENTION

1. Field of the Invention

This invention relates to a device for allowing a single user to make accurate measurements, lay out structures or designs on surfaces, and draw arcs.

2. Description of the Related Art

The inventor is aware of a number of patents which cover devices for finding a given point on a plane.

U.S. Pat. No. 4,412,383 applies to a cable-driven plotter cites U.S. Pat. No. 3,564,533 as having “. . . one of the ends of each of two cables . . . pivotally connected to a common handpiece. As an operator moves the handpiece over the points in a graphic image, the changes in the lengths of the cables are recognized by . . . encoders and recorded.” It is observed that this is the opposite function of a plotter. The plotter of U.S. Pat. No. 4,412,383 utilizes a third cable to “tension” the other two cables. The known length of the two cables is then utilized to cause the handpiece to move to a desired point on a plane.

Two “variable length arms” are mounted a fixed distance apart and utilized to locate a point in the device of U.S. Pat. No. 4,979,093.

The preceding patents, however, deal with only a limited area.

U.S. Pat. No. 5,408,407 locates a work point on a vertical surface by having two devices control the length of two cables attached to a weight.

Two tape measures each have one end pivotally attached to one of two blocks on a surface. A given point will be located by finding the point where the two tape measures intersect at a specificed distance for each tape measure. The blocks are, however, just very rudimentary structures.

And U.S. Pat. No. 5,142,787 applies to triangular bases to which cables are attached at defined angles for laying out “a static structure, such as a building or the like.”

### SUMMARY OF THE INVENTION

The present Measurement Device is constructed to use two measuring tapes together with three of the Measurement Devices to find a given point within a plane (or the projection of that plane upon an uneven surface) and thereby facilitate laying out a building or other structure or design, such as a court for an athletic game, upon a surface.

According to well-known mathematical principles, when the distance between two devices, each having a measuring tape rotatably attached to such device, is known, any point within a plane can be determined by having the two tapes intersect at an appropriate distance along each tape.

The present Measurement Device permits a single person to make such a determination in an accurate manner.

This Measurement Device has at least one point of rotation and a releasable fastener for a measuring tape which holds the tape so that such fastener will, when a section of the measuring tape between the fastener and the point of application for a pulling force is straightened by being pulled taut, align the point of rotation with the straightened measuring tape.

Furthermore, the Measurement Device has a visual index point the position of which can be viewed on the measuring tape when the measuring tape is held by the fastener such that the distance from the point of rotation to any position of the measuring tape beyond the fastener is known.

Alternatively, when it is desired to have a portion of a measuring tape other than the free end attached to the measurement device, the first releasable fastener can be employed merely as a guide for the measuring tape; and a second releasable fastener located near a first side of the Measurement Device would actually retain the tape so that the tape container could lie on the surface upon which measurements are being made with tape going from the second releasable fastener to the tape container in such a manner as not to impede the rotation of the Measurement Device.

Because, when the Measurement Devices are utilized to locate a point within a plane, two Measurement Devices are positioned at fixed points a known distance apart, each having a measuring tape attached to such Measurement Device; and the third Measurement Device has both measuring tapes attached to it, using two separate upper sections. Typically, the free ends of the tapes are attached to the upper sections of the third Measurement Device (or locator assembly) to facilitate their unimpeded rotation.

The elements of the Measurement Device discussed so far are all located upon an upper section. The upper section is adapted for rotational attachment to a base. Preferably, the upper section has a circular aperture which fits rotatably about a cylindrical projection from the base. The center of the rotation for the upper section is designated the point of rotation. To the point of the base that is aligned with the point of rotation can be connected, preferably releasably, a device for visually aligning the point of rotation with a point on the surface; this can, for example, be physical pointer, a laser pointer, a swivel to hold a line for a plumb bob, or a holder for pencil lead or other marking device.

When using a third Measurement Device to locate a point on a layout surface, two upper sections are rotatably attached to the same base. To enhance accuracy, a spacer having the same vertical dimension as an upper section is inserted between the base and the upper section which is connected to the tape that is also connected to the higher of the two upper sections that are on the same base.

A base that is intended to be stationary during the measurement process can be fastened to the surface with nails, screws, or spikes placed through apertures provided in the base. A base can also be mounted using double-sided tape, or it can be secured to irregular surfaces or fixtures using clamps.

Also, and in lieu of the device for visual alignment, an adapter can be connected, preferably releasably, to the point of the base that is substantially aligned with the point of rotation. The adapter permits the base to be attached to a tripod that is normally used for a transit. Three threaded apertures in the base permit screws to be used for leveling the base. If desired, the upper section could also contain a leveling aid, such as a bubble level.

The tripod can then enable the Measurement Devices to be used for a layout over an uneven surface.

Also, an extension device can be attached to a base to allow for a range of vertical adjustment of the upper section smaller than attained through the use of a tripod.

To permit the upper section to be used without the base, an auxiliary aperture, through which a nail or screw can be inserted preferably exists in the upper section at a known distance between the first releasable fastener and the point of rotation.

Then a pencil or other marker inserted through the auxiliary aperture in a second upper section can be used to draw an arc when the first upper section and the second upper section are connected to the same measuring tape.

Of course, when a base has a pencil lead holder, two sets of bases and upper sections can be utilized even more accurately to draw such an arc.

The spacer can be fastened to the base with a thumb screw. Thus, the spacer, if desired, may be placed above an upper section more securely to hold the upper section to the base.

And two threaded circular apertures are provided in the upper section situated so that the front of each alignment aperture is substantially aligned with a line drawn through the center of the point of rotation and perpendicular to the intended direction for a measuring tape. Consequently, two screws can be placed in such apertures. When such screws are of sufficient length to stabilize the upper section, a measuring tape can be attached to the first releasable fastener while the screws hold the upper section against an edge of a surface so that a single person can measure a distance on the surface.

Finally a channel on the lower side of the upper section permits a string for a chalk line to be retained by the upper section.

### BRIEF DESCRIPTION OF THE DRAWINGS

FIG. 1 is an isometric view, taken from above, showing the upper section of a Measurement Device.

FIG. 2 is an isometric view, again pictured from above, illustrating the base of a Measurement Device.

FIG. 3 illustrates an adapter for connecting the Measurement Device to a tripod.

FIG. 4 depicts an extension tube attached to a base in order to support an upper section at an increased height.

FIG. 5 shows a spacer.

FIG. 6 is an isometric view, taken from below, showing the upper section of a Measurement Device.

### DESCRIPTION OF THE PREFERRED EMBODIMENT

The principal component for the Measurement Device of the present invention is an upper section 1. The second major component is a base 2.

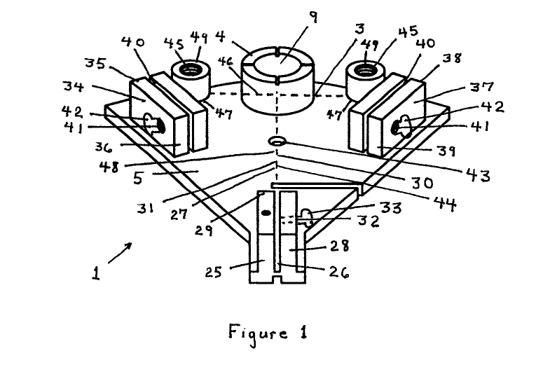

As illustrated in FIG. 1, an upper section 1 has a circular aperture 3 and, preferably, for stability, a cylinder 4 designated a stabilizing cylinder 4 attached to and extending upward from the top 5 of the upper section 1 around the circular aperture 3.

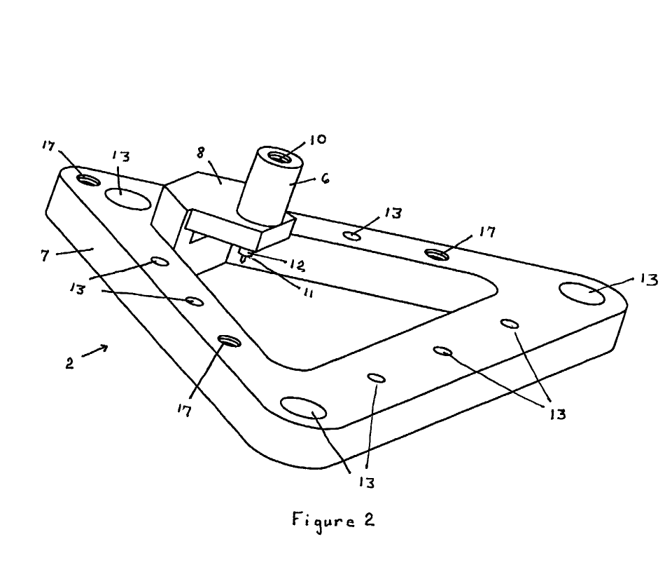

The base 2, as illustrated in FIG. 2, has a cylindrical projection 6 attached to and rising from a support 7, which is preferably a generally triangular perimeter, preferably by being mounted to an extension 8 that is connected to the perimeter 7.

The circular aperture 3 of the upper section 1 fits rotatably about the cylindrical projection 6 of the base 2. As mentioned above, the center of the rotation for the upper section 1, which is substantially at the center of the circular aperture 3, is designated the point of rotation 9.

Preferably, the inside of the cylindrical projection 6 is hollow and threaded about the longitudinal center 10 of the cylindrical projection 6, thereby aligning the center 10 of the cylindrical projection 6 with the point of rotation 9, in order to permit a releasable connection to the cylindrical projection 6 a device 11 for visually aligning the point of rotation 9 with a point on a surface upon which measurements are to be made. The device 11 has a threaded first end 12; the other end can be a physical pointer (as illustrated in FIG. 2), a laser pointer, a swivel to hold a line for a plumb bob, or a holder for pencil lead or other marking device.

As noted above, a base 2 can be fastened to a surface upon which measurements are to be made with nails, screws, or spikes placed through apertures 13 existing in the support 7 of the base 2; a base 2 can also be mounted using double-sided tape or secured to irregular surfaces or fixtures through the use of clamps.

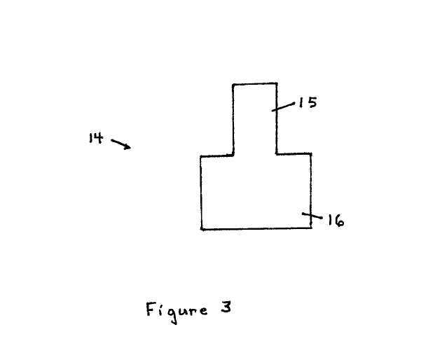

In lieu of the device 11 for visual alignment, an adapter 14, having a threaded first end 15 and a threaded second end 16 illustrated in FIG. 3, can, as observed above, have its first end 15 screwed into the cylindrical projection 6 and its second end 16 attached to a tripod that is normally used for a transit. Three threaded apertures 17 in the support 7 of the base 2 permit screws to be used for leveling the base 2 in any manner that is well known in the art. Optionally, the upper section contains a leveling aid (not illustrated), such as a bubble level.

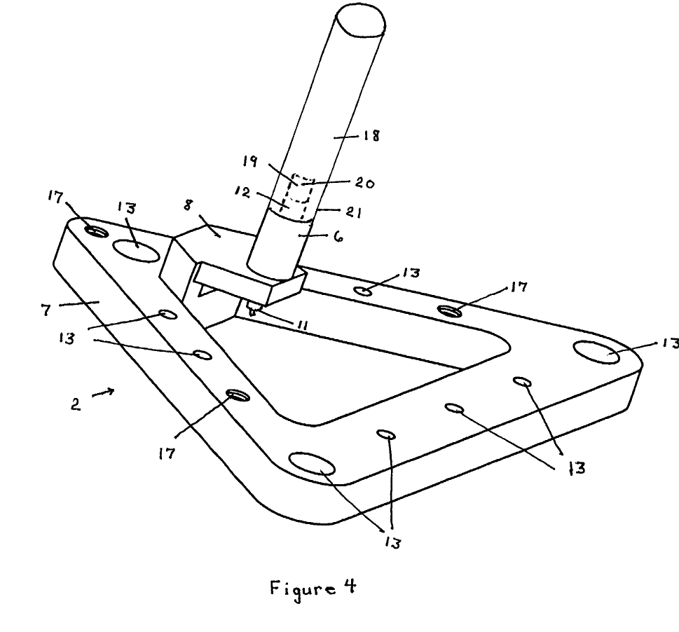

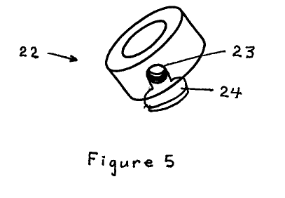

The tripod, thus, enables, as mentioned above, the Measurement Devices to be used for a layout over an uneven surface. For smaller vertical adjustments, an extension tube 18, preferably having a threaded core 19 about its longitudinal center 20 at a first end 21, is attached at said first end 21, preferably removably, to the top of the cylindrical projection 6, preferably by having the threaded first end 12 of the device 11 for visual alignment be of such a length that it extends above the cylindrical projection 6 so that the extension tube 18 can be screwed onto such threaded first end 12, as illustrated in FIG. 4. An upper section 1 is supported at a desired position along the extension tube 18 by a spacer 22, shown in FIG. 5, that surrounds the extension tube 18 and has a threaded aperture 23 through which a thumb screw 24 can be tightened to secure the spacer 22 to the extension tube 18.

Each upper section 1 has a first releasable fastener 25 having a central channel 26 lying along an imaginary radius 27 extending from the point of rotation 9. The first releasable fastener 25 has a farther end 28 from the point of rotation 9 and a nearer end 29. The farther end 28 is at a known distance 30, preferably four inches, from the point of rotation 9; and the nearer end 29 is at another known distance 31, preferably three inches, from the point of rotation 9. The first releasable fastener 25 has a threaded aperture 32 through which a thumb screw 33 can be tightened to secure a measuring tape within the central channel 26.

Preferably, each upper section 1 also has a second releasable fastener 34 having a nearer end 35 and a farther end 36 as well as a third releasable fastener 37 having a nearer end 38 and a farther end 39. Each nearer end 35, 38 is the same distance from the farther end 28 of the first releasable fastener 25 as is the point of rotation 9. The second and third releasable fasteners 34, 37 each possess a central channel 40 and a threaded aperture 41 through which a thumb screw 42 can be tightened to secure a measuring tape within the central channel 40.

Optionally, the upper section 1 has an auxiliary aperture 43 to be used as an auxiliary point of rotation by having a nail placed through the auxiliary aperture 43 into the surface upon which measurements are to be made. The center of the auxiliary aperture 43 is a known distance 44, preferably three inches, from the farther end 28 of the first releasable fastener 25; and the farther ends 36, 39 of the second and third releasable fasteners 34, 37 are the same distance from the farther end 28 of the first releasable fastener 25 as is the center of the auxiliary aperture 43.

Also optionally, two threaded circular apertures 45 are located in the upper section 1 such that an imaginary line 46 drawn between the front 47 of each threaded circular aperture 45 will be substantially aligned with the point of rotation 9 and perpendicular to an imaginary line 48 drawn between the point of rotation 9 and the first releasable fastener 25. A hollow, threaded stabilizing cylinder 49 is attached to and extends upward from the top 5 of the upper section 1 around each threaded circular aperture 45. Screws placed through the threaded circular apertures 45 to a sufficient degree that they extend below the upper section 1 then form an L-shaped structure with the upper section 1 so that, when the upper section 1 with screws extending below the upper section has been placed on a surface with such screws abutting the edge of the surface, a measuring tape that extends through the first releasable fastener 25 can be pulled taut by a single user without dislodging the upper section 1 with the screws. Thereby a single user can measure a distance across the surface.

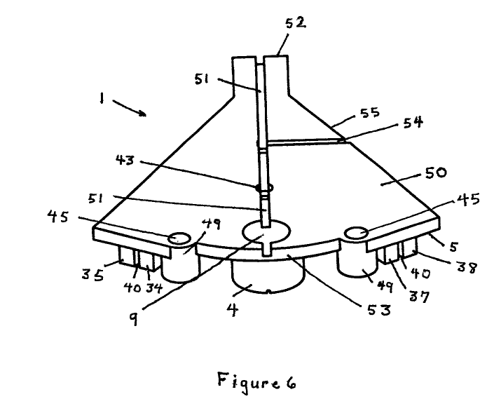

Finally, as illustrated in FIG. 6, the upper section 1 optionally has on its lower side 50 a channel 51 extending radially from the point of rotation 9, past the auxiliary aperture 43 (if the embodiment of the upper section 1 includes and auxiliary aperture 43), and below the first releasable fastener 25 to the front 52 of the upper section 1 to accommodate a cord for a chalk line; preferably, the channel 51 also extends radially from the point of rotation 9 to the rear 53 of the upper section 1. Also optionally, a channel 54 that runs from the top 5 of the upper section 1 to the lower side 50 of the upper section 1 extends from a first side 55 of the upper section 1 to the channel 51 to permit a cord for a chalk line to pass from the lower side 50 to the top 5 of the upper section 1.

To locate a given point on a surface if the surface is planar, two bases 2 are attached to the surface a known distance apart. The distance that the given point is located from each of the bases 2 can be computed according to techniques that are well known in the art. The end of a first measuring tape to which the reel within which the tape can be wound is then placed in an upper section 1 past either the second releasable fastener 34 with the desired length indicator on the measuring tape being even with the farther end 36 of the second releasable fastener 34 or the third releasable fastener 37 with the desired length indicator on the measuring tape being even with the farther end 39 of the third releasable fastener 37. The measuring tape, in the direction away from the reel, extends through the first releasable fastener 25. A second measuring tape is similarly located in a second upper section 1. Each upper section 1 is rotatably placed upon the appropriate base 2.

The free end of the first measuring tape is fastened in the first releasable fastener 25 of a third upper section 1 with the length indicator on the measuring tape aligned with the farther end 28 of the first releasable fastener and showing the distance from the farther end 28 to the point of rotation 9. The free end of the second measuring tape is similarly situated in the first releasable fastener 25 of a fourth upper section 1.

The third and fourth upper sections 1 are rotatably place upon a third base 2. Of course, one of such upper sections 1 will be above the other on the cylindrical projection 6 of the third base 2. Therefore, to optimize the accuracy of the measurement, the spacer 22 is of the same height as the stabilizing cylinder 4 so that a spacer 22 is inserted on the cylindrical projection 6 of the base 2 which supports the upper section 1 holding the end with the reel of the measuring tape the free end of which is attached to the higher upper section 1 on the third base 2. When the upper section 1 holding the end of the measuring tape with the reel for the measuring tape the free end of which is higher on the cylindrical projection 6 that holds two upper sections 1 is placed above the spacer 22 on the cylindrical projection 6 of the third base 2, the measuring tape will be level.

The base 2 with the two upper sections 1 is then moved until both measuring tapes are taut. The point which is sought then lies where the device for visually aligning 11 projects onto the surface.

If the surface upon which measurements are to be made is uneven, measuring tapes are kept level by utilizing the extension tube 18 described above; or, if changes in elevation exceed the length of the extension tube 18, a base 2 is attached to a tripod as described above.

And, as discussed earlier, when a first upper section 1 is attached to a surface by having a nail pass through the auxiliary aperture 43 of the first upper section and is attached with a measuring tape to a second upper section 1, a pencil or other marker inserted through the auxiliary aperture 43 in the second upper section 1 can be used to draw an arc upon the surface. And when a base 2 has a holder for holder for pencil lead or other marking device, such base 2, another base 2, and a measuring tape can be utilized even more accurately to draw such an arc.

I claim:

1. A measurement device, which comprises:
a base;
an upper section having a point of rotation; and
a means for rotatably attaching said upper section to said base, wherein said upper section further comprises
a releasable fastener for a measuring tape located radially from said means for rotatably attaching, and
a visual index point, and wherein said base further comprises
a means for visually aligning the point of rotation for said upper section with a point on a surface upon which a measurement is to be made.

2. The measurement device as recited in claim 1, further comprising:
a means for attaching said base to a surface upon which a measurement is to be made.

3. A measurement device, which comprises:
an upper section having a top and a circular aperture creating a point of rotation substantially at the center of such circular aperture, said upper section further comprising a first releasable fastener lying along an imaginary radius extending from the point of rotation and the releasable fastener having a farther end at a known distance from the point of rotation;
a base comprising a support with a cylindrical projection attached to and rising from the support for rotatably receiving the circular aperture of said upper section; and
connected to the cylindrical projection, a device for visually aligning the point of rotation with a point on a surface upon which measurements are to be made.

4. The measurement device as recited in claim 3, further comprising:
a stabilizing cylinder attached to and extending upward from the top of said upper section around the circular aperture;
a second releasable fastener on said upper section, said second releasable fastener having a nearer end and a farther end, the nearer end of said second releasable fastener being the same distance from the farther end of the first releasable fastener as is the point of rotation; and
a third releasable fastener on said upper section, said third releasable fastener having a nearer end and a farther end, the nearer end of said third releasable fastener being the same distance from the farther end of the first releasable fastener as is the point of rotation.

5. The measurement device as recited in claim 4, wherein:
said upper section has an auxiliary aperture and two threaded circular apertures each having a front, said threaded circular apertures located such that an imaginary line drawn between the front of each threaded circular aperture will be substantially aligned with the point of rotation and perpendicular to an imaginary line drawn between the point of rotation and said first releasable fastener; and further comprising
a stabilizing cylinder attached to and extending upward from the top of said upper section around each threaded circular aperture.

6. The measurement device as recited in claim 5, wherein:
said base has apertures in the support of said base for mounting said base on a surface upon which a measurement is to be made.

7. The measurement device as recited in claim 6, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

8. The measurement device as recited in claim 5, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

9. The measurement device as recited in claim 4, wherein:
said base has apertures in the support of said base for mounting said base on a surface upon which a measurement is to be made.

10. The measurement device as recited in claim 9, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

11. The measurement device as recited in claim 4, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

12. The measurement device as recited in claim 3, wherein:
said upper section has an auxiliary aperture and two threaded circular apertures each having a front, said threaded circular apertures located such that an imaginary line drawn between the front of each threaded circular aperture will be substantially aligned with the point of rotation and perpendicular to an imaginary line drawn between the point of rotation and said first releasable fastener; and further comprising
a stabilizing cylinder attached to and extending upward from the top of said upper section around each threaded circular aperture.

13. The measurement device as recited in claim 12, wherein:
said base has apertures in the support of said base for mounting said base on a surface upon which a measurement is to be made.

14. The measurement device as recited in claim 13, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

15. The measurement device as recited in claim 12, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

16. The measurement device as recited in claim 3, wherein:
said base has apertures in the support of said base for mounting said base on a surface upon which a measurement is to be made.

17. The measurement device as recited in claim 16, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.

18. The measurement device as recited in claim 3, wherein:
the support of said base has three threaded apertures to permit screws to be used for leveling the base;
the device for visual alignment is selected from the group consisting of a physical pointer, a laser point, a swivel for holding a line for a plumb bob, and a holder for a marking device; and further comprising:
for use in lieu of the device for visual alignment, an adapter for attaching the Measurement Device to a tripod; and
an extension tube adapted for attachment to the top of the cylindrical projection.
